(19) United States
(12) Patent Application Publication
(10) Pub. No.: US 2013/0006578 A1
(43) Pub. Date: Jan. 3, 2013

(54) Device and Method for Detecting Light Reflection and Electronic Device Using the Same

(76) Inventors: Kai-Chen Lin, New Taipei City (TW); Chang-Ming Lee, New Taipei City (TW)

(21) Appl. No.: 13/253,980

(22) Filed: Oct. 6, 2011

(30) Foreign Application Priority Data
Jun. 28, 2011 (TW) 100122614

(51) Int. Cl. G06F 19/00; G01B 11/26

(52) U.S. Cl. 702/151

(57) ABSTRACT

The present disclosure discloses a device for detecting light reflection in an electronic device having a display device includes a light angle detection module for detecting an incident angle of light beam emitted from a light source corresponding to the display device, a vision angle detecting module for detecting a visual angle of a user corresponding to the display device, and a processing module for determining the light source affects the user when the incident angle is smaller than a first default value and the visual angle is smaller than a second default value.

### BACKGROUND OF THE INVENTION

1. Field of the Invention

The present disclosure relates to a device and a method for detecting light reflection and an electronic device using the same, and more particularly, to a device and a method for detecting light reflection and an electronic device using the same for determining whether a light source affects a user because of light reflection of a display.

2. Description of the Prior Art

Portable electronic devices with display function, e.g. laptops, tablets, smart phones, etc., feature compact size, light weight and portability, allow users to have powerful calculating and document processing ability on the go, and provide complete video multimedia function. In order to achieve portability, a portable electronic device is usually equipped with a thin flat panel display, such as liquid crystal display (LCD), and the surface of the thin flat panel display is mostly made of a reflective material. In such a condition, the user is usually affected by light reflection of the thin flat panel display, and therefore, feels inconvenience.

For example, as shown in FIG. 1, a user 100 operates a notebook 104 under a light source 102, e.g. the sun or a light bulb. Since the display device of the notebook 104 has light reflection effects, the light source 102 is reflected to a vision area of the user 100 via the display device of the notebook 104. In such a situation, if the intensity of the light source 102 is low, the user 100 generally ignores slight light reflection and continuously concentrates on images shown on the display device of the notebook 104, such that light reflection tremendously harms eyes of the user 100 in a prolonged use.

### SUMMARY OF THE INVENTION

Therefore, the present disclosure mainly provides a device and a method for detecting light reflection and an electronic device using the same.

One aspect of the present disclosure discloses a device for detecting light reflection in an electronic device which has a display device. The device for detecting light reflection comprises a light source angle processing module, for detecting a incident angle of the light beam emitted from a light source corresponding to the display device; a vision angle detection module, for detecting a vision angle of the user corresponding to the display device; and a processing module, for determining the light source affects the user when the incident angle is smaller than a first predetermined value and the vision angle is smaller than a second predetermined value.

Another aspect of the present disclosure further discloses a method for detecting light reflection in an electronic device having a display device, comprising detecting a incident angle of the light beam emitted from a light source corresponding to the display device; detecting a vision angle of a user corresponding to the display device; and determining the light source affects the user when the incident angle is smaller than a first predetermined value and the vision angle is smaller than a second predetermined value.

One another aspect of the present disclosure further discloses an electronic device, comprising an operating circuit; a display device, controlled by the operating circuit to display images; and a device for detecting light reflection, comprising a light angle detection module, for detecting a incident angle of the light beam emitted from a light source corresponding to the display device; a vision angle detection module, for detecting a vision angle of the user corresponding to the display device; and a processing module, for determining the light source affects the user when the incident angle is smaller than a first predetermined value and the vision angle is smaller than a second predetermined value.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of light reflection generated by a notebook in the prior art.

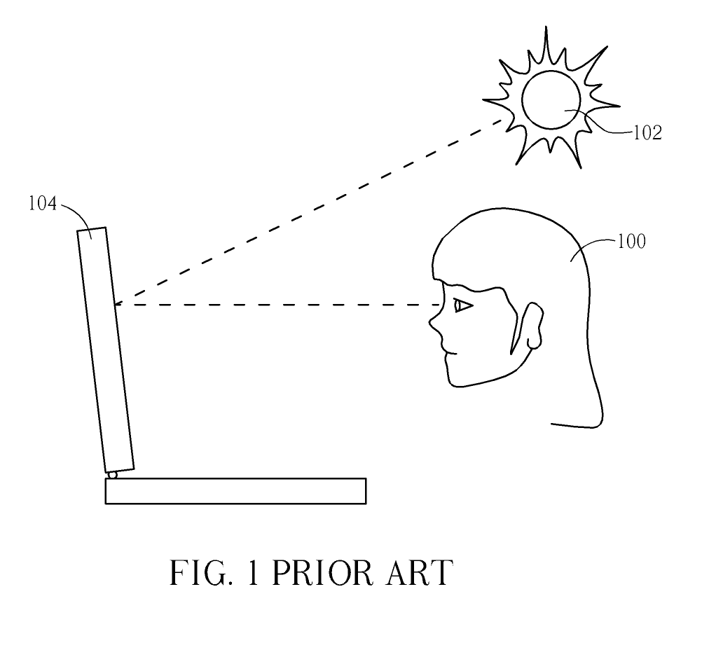

FIG. 2A illustrates a schematic diagram of an appearance of a light reflection detection device according to an embodiment of the present disclosure.

FIG. 2B illustrates a functional block diagram of the light reflection detection device shown in FIG. 2A.

FIG. 2C illustrates a schematic diagram of operations of the light reflection detection device shown in FIG. 2A.

FIG. 3A illustrates a schematic diagram of an embodiment of a light angle detection module shown in FIG. 2B.

FIG. 3B illustrates a schematic diagram of an embodiment of luminous flex detectors shown in FIG. 3A.

FIG. 4A illustrates a schematic diagram of an embodiment of a vision angle detection module shown in FIG. 2B.

FIG. 4B illustrates a schematic diagram of operations of a calculating unit shown in FIG. 4A.

FIG. 5 illustrates a schematic diagram of a light reflection detection process according to an embodiment of the present disclosure.

### DETAILED DESCRIPTION

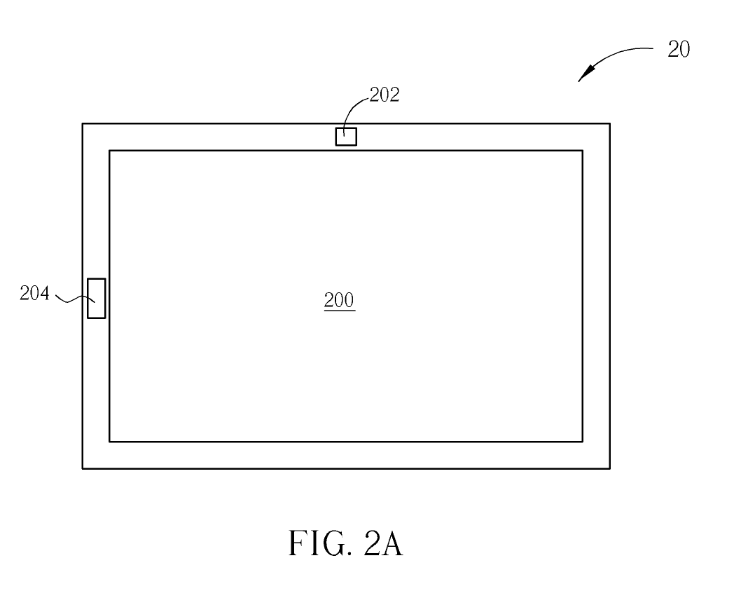

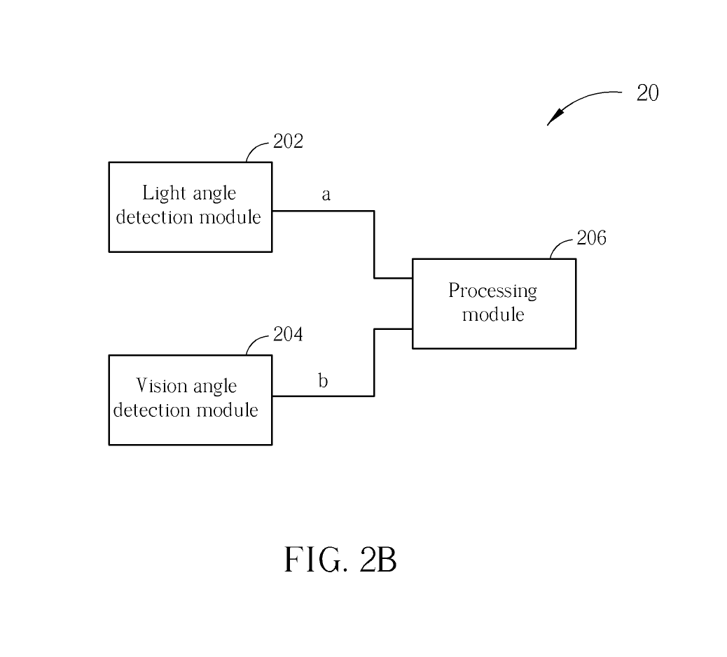

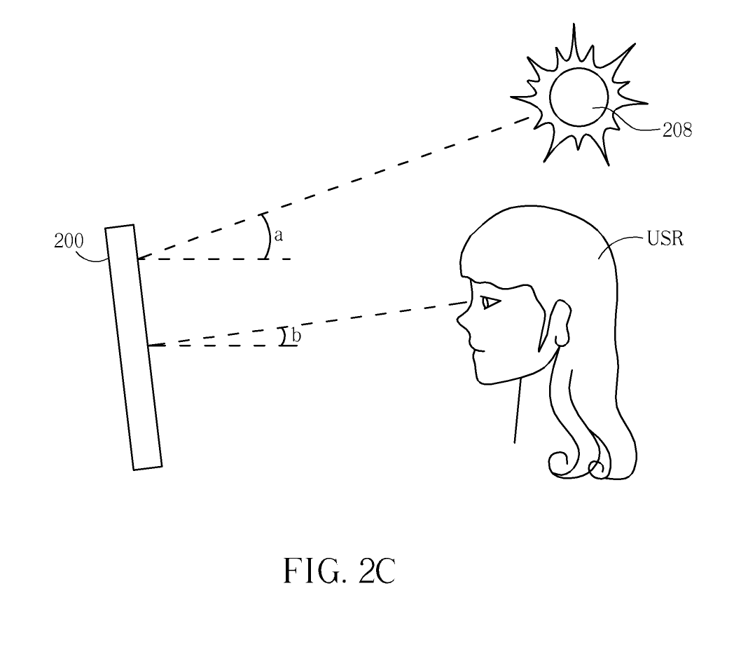

Please refer to FIG. 2A-FIG. 2C. FIG. 2A illustrates a schematic diagram of an appearance of a light reflection detection device 20 according to an embodiment of the present disclosure. FIG. 2B illustrates a functional block diagram of the light reflection detection device 20. FIG. 2C illustrates a schematic diagram of operations of the light reflection detection device 20. The light reflection detection device 20 is utilized for detecting light reflection of a display device 200. The display device 200 can be an independent display or a flat panel display disposed in an electronic device, e.g. a notebook, a tablet, etc. The light reflection detection device 20 comprises a light angle detection module 202, a vision angle detection module 204, and a processing module 206. The light angle detection module 202 is utilized for detecting an incident angle a of the light beam emitted from a light source 208 corresponding to the display device 200. The vision angle detection module 204 is utilized for detecting a vision angle b of a user USR corresponding to the display device 200. The processing module 206 determines the light source 208 affects the user USR when the incident angle a is smaller than a predetermined value α and the vision angle b is smaller than a predetermined value β. Therefore, when the light source 208 affects the user, the light reflection detection device 20 of the present disclosure timely determines the user USR may be affected by light reflection of the display device 200. Furthermore, in an embodiment, the processing module 206 can output a notification message or warning message, such as showing an image or a line of words on the display device 200 or uttering a sound, to notify the user USR may be affected by light reflection. As a result, the user USR can adjust the angle or position of viewing the display device 200, to avoid effects of light reflection of the display device 200.

Furthermore, as shown in FIG. 2C, the incident angle a is an angle of light beams emitted from the light source 208 corresponding to a normal or vertical line of the display device 200, and the vision angle b is an angle of the user USR corresponding to the normal of the display device 200 when the user USR directly looks at the display device 200. Therefore, when the incident angle a and the vision angle b are both within a certain range (i.e. smaller than the predetermined values α and β), the user USR may be affected by the light source 208 through light reflection of the display device 200. In such a condition, the light reflection detection device 20 detects light reflection, and timely notifies the user to avoid effects of external reflected light.

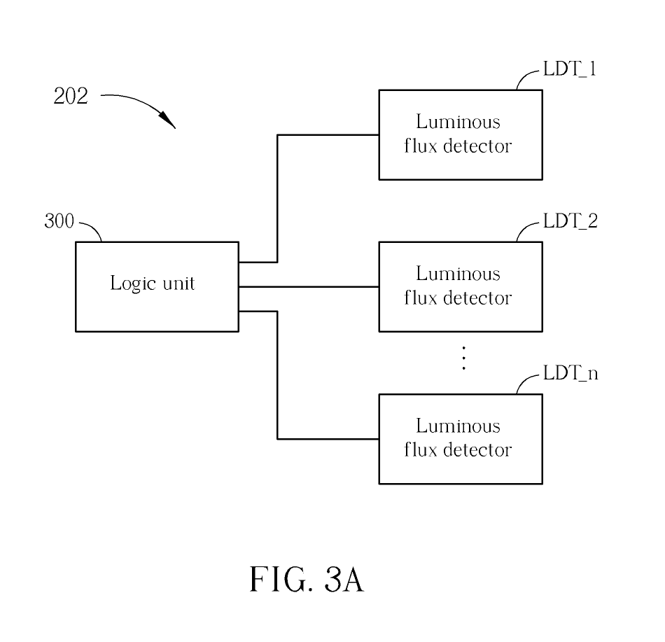

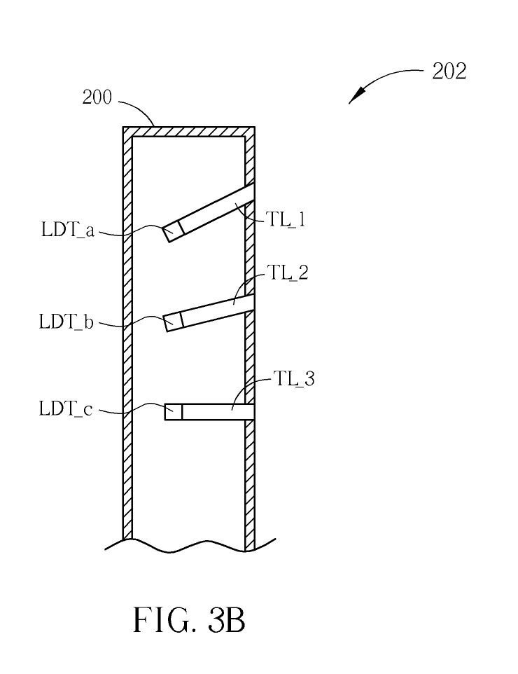

FIG. 2A-FIG. 2C are utilized for illustrating the concept of the present disclosure, and all the alternations thereof belong to the scope of the present disclosure. For example, there are many methods for the light angle detection module 202 to measure the incident angle a, and electronic devices, components or the combinations thereof capable of correctly measuring the incident angle a of the light source 208 can be utilized in the present disclosure. For example, FIG. 3A is a schematic diagram of the light angle detection module 202 according to an embodiment of the present disclosure. As shown in FIG. 3A, the light angle detection module 202 consists of luminous flux detectors LDT_1-LDT-n and a logic unit 300. The luminous flux detectors LDT_1-LDT_n detect luminous fluxes of n angles between light beams emitted from the light source 208 and the display device 200. The logic unit 300 determines an angle corresponding to a luminous flux detection result having the maximum luminous flux as the incident angle a according to the luminous flux detection results from the luminous flux detectors LDT_1-LDT_n. In other words, if the luminous flux detector LDT_1 detects the luminous flux on the normal of the display device 200 (i.e. the luminous flux of a vertical direction of a display plane of the display device 200), when the luminous flux detection result of the luminous flux detector LDT_1 indicates the maximum luminous flux detection result, the light source 208 is approximately on the normal of the display device 200, which means the incident angle a is 0. By the same token, as long as the number n of the luminous flux detectors LDT_1-LDT_n and the corresponded incident angles thereof are appropriately decided, the incident angle of the external light source can be correctly determined.

There are many methods to implement the luminous flux detectors LDT_1-LDT_n, and those skilled in the art can appropriately make adjustments according to system requirements. For example, if the number of required luminous flux detectors is 3, respectively corresponding to 0 degrees, 30 degrees, 60 degrees, then implementation of the light angle detection module 202 can match a housing of the display device 200, to achieve the goal of detecting luminous fluxes corresponding to different angles. For example, as shown in FIG. 3B, tubes TL_1-TL_3 and light sensors LDT_a-LDT_c form three luminous flux detectors, wherein the tubes TL_1-TL_3 are formed inside of the housing of the display device 200, and angles of the tubes TL_1-TL_3 corresponding to the normal of the display device 200 are 0 degrees, 30 degrees, 60 degrees, respectively. The light sensors LDT_a-LDT_c are semiconductors or electronic components implemented in the same method, which means the light sensors LDT_a-LDT_c do not have function of identifying angles, but identify different angles via the tubes TL_1-TL_3. Therefore, combinations of the tubes TL_1-TL-3 and the light sensors LDT_a-LDT_c can detect luminous fluxes of 0 degrees, 30 degrees, 60 degrees, and the logic unit 300 can accordingly determine the incident angle a of the light source 208.

Besides, to avoid misjudgments, the light angle detection module 202 can firstly determine intensity of the light source 208, and start to detect the incident angle a of the light beams emitted from the light source 208 corresponding to the display device 200 when the detected intensity of the light source 208 is greater than a predetermined value. In addition, when there are multiple light sources, the light processing module 202 can select the light source which has the relatively maximum intensity or the light source probably generating light reflection as reference for determining the incident angle a.

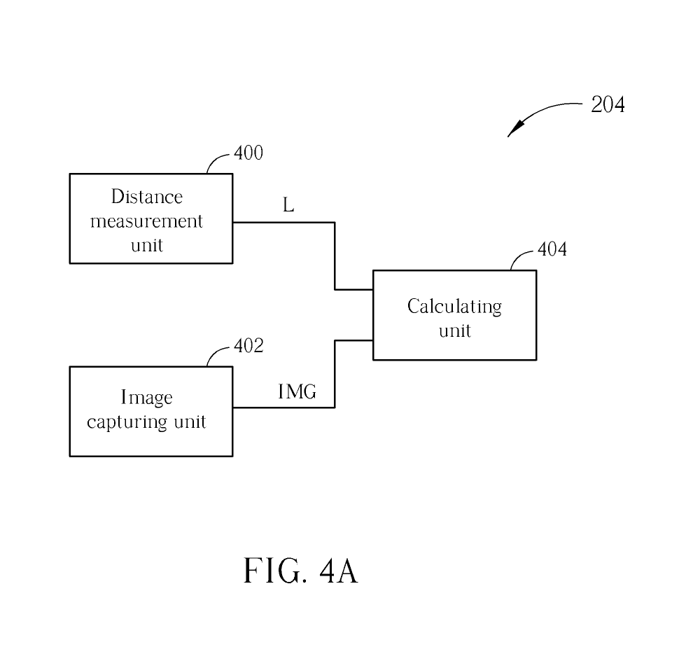

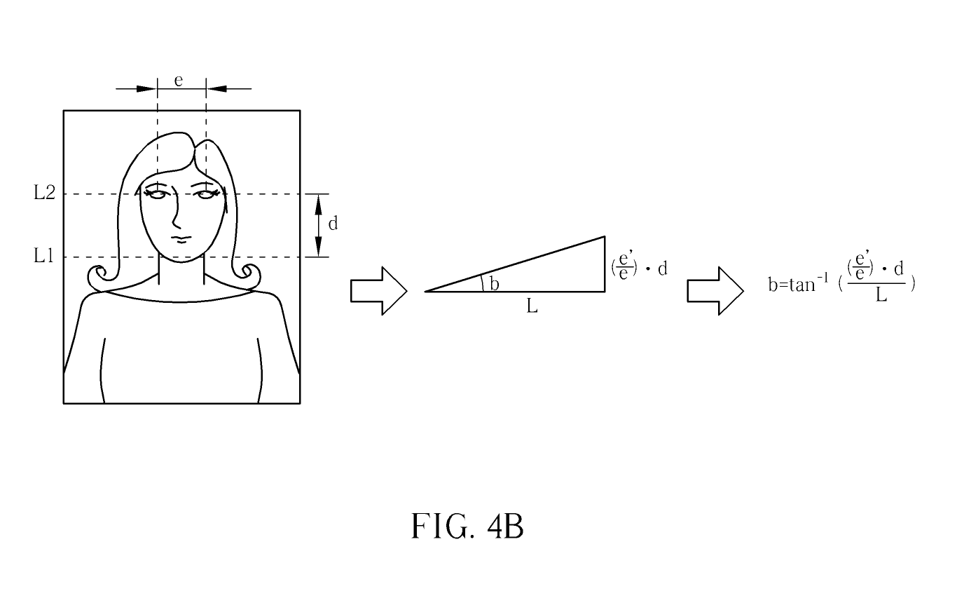

On the other hand, there are many methods for the vision angle detection module 204 to measure the vision angle b, and all the electronic devices, electronic components or combinations of electronic components capable of correctly calculating the vision angle b of the user USR are suitable for the present disclosure. For example, please refer to FIG. 4A, which illustrates a schematic diagram of the vision angle detection module 204 according to an embodiment of the present disclosure. As shown in FIG. 4A, the vision angle detection module 204 comprises a distance measurement unit 400, an image capturing unit 402 and a calculating unit 404. The distance measurement unit 400 is utilized for measuring a distance L between the user USR and the display device 200. The image capturing unit 402 is utilized for capturing a face image IMG of the user USR corresponding to the display device 200. The calculating unit 404 is utilized for determining the vision angle b of the user USR corresponding to the display device 200 according to the distance L and the face image IMG

Please refer to FIG. 4B, which illustrates a schematic diagram of operations of the calculating unit 404. As shown in FIG. 4B, after the image capturing unit 402 outputs the face image IMG of the user USR to the calculating unit 404, the calculating unit 404 initially recognizes eyes of the user USR in the face image IMG. Then, the calculating unit 404 determines the distance e between pupils of the eyes of the user USR, to determine a ratio of the image IMG to the actual face. In other words, assuming the actual distance between the pupils of the user USR is e′ (e.g. 3.5 cm), and the ratio of the face image IMG to the actual face is e′/e. Then, the calculating unit 404 determines a distance d between a horizontal center line L1 of the face image IMG and a horizontal line L2 of the eyes. Finally, based on the trigonometric theory, the calculating unit 404 determines the vision angle according to the determined distance e, d, L. In other words,

$$b = {tan}^{- 1} ( \frac{( \frac{{e}^{′}}{e} ) \cdot d}{L} ) .$$

Furthermore, FIG. 4A and FIG. 4B is one of possible embodiments of the vision angle detection module 204, but the present disclosure is not limited thereto. Brief speaking, the method of measuring the vision angle b needs to first determine the position of the eyes of the user USR, then to determine the angle of the user USR corresponding to the normal of the display device 200. Besides, the horizontal line L2 is preferable to the horizontal line of the eyes. However, when the eyes are not in the same horizontal level, the horizontal line L2 can also be an extended horizontal line from the center point between the eyes in vertical direction. Besides, e′ represents the actual distance between the pupils, and can be a system predetermined value or predetermined by the user USR. Moreover, the method for measuring the distance d can respectively calculate a first distance from the horizontal line L1 to the top of the face image IMG and a second distance from the horizontal line L2 to the top of the face image IMG, and the distance d can be derived from subtracting the second distance from the first distance.

Furthermore, the distance measurement unit 400 is not limited to any kind of measuring principle, such as infrared, supersonic, laser, etc., as long as the distance L can be correctly measured. Similarly, the image capturing unit 402 can be CCD, CMOS, etc., as long as the image of the user USR can be correctly captured. Besides, the calculating unit 404 is a device or a component capable of executing math operations, and can be combined with the logic device 300 shown in FIG. 3A or implemented as an additional function via firmware or processor originally equipped in the display device 200, and is not limited thereto.

On the other hand, in the light reflection detection device 20, the processing module 206 compares the incident angle a with the predetermined value α and the vision angle b with the predetermined value β. When a<α and b<β, the processing module 206 determines the user USR is affected by light reflection of the display, wherein the predetermined values α and β can be equal, such as 30 degrees, or can be different.

Therefore, by determining the incident angle a of the light source 208 and the vision angle b of the user USR, the light reflection detection device 20 determines whether the light source 208 affects a using state of the user USR, to avoid light reflection from affecting eyesight of the user USR or usage convenience. Noticeably, the light reflection detection device 20 can be applied to any electronic device having a flat panel display. How to design the operation circuit of the electronic devices or how the operation circuit controls the flat panel display device is not the main concern of the present disclosure.

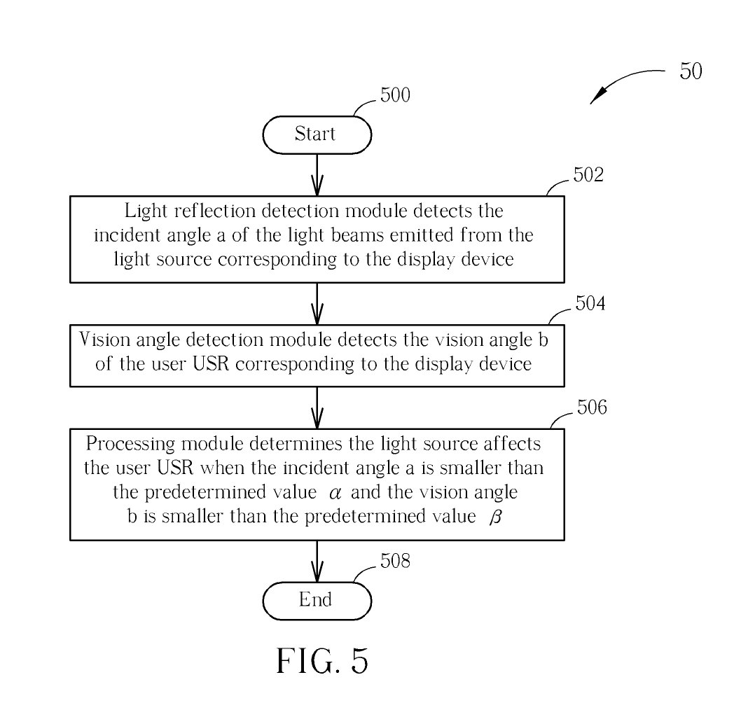

The above mentioned operations of the light reflection detection device 20 can be further summarized into a light reflection detection process 50, as shown in FIG. 5. The light reflection detection process 50 comprises:

Step 500: Start.

Step 502: The light reflection processing module 202 detects the incident angle a of the light beams emitted from the light source 208 corresponding to the display device 200.

Step 504: The vision angle detection module 204 detects the vision angle b of the user USR corresponding to the display device 200.

Step 506: The processing module 206 determines the light source 208 affects the user USR when the incident angle a is smaller than the predetermined value α and the vision angle b is smaller than the predetermined value β.

Step 508: End.

The detailed description and alterations of the light reflection detection process 50 can be referred to the above, and are not narrated hereinafter for simplicity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A device for detecting light reflection in an electronic device having a display device, comprising:
a light angle detection module, for detecting an incident angle of a light beam emitted by a light source corresponding to the display device;
a vision angle detection module, for detecting a vision angle of a user corresponding to the display device; and
a processing module, for determining the light source affects the user when the incident angle is smaller than a first predetermined value and the vision angle is smaller than a second predetermined value.

2. The device of claim 1, wherein the light angle detection module comprises:
a plurality of luminous flux detectors, for detecting luminous fluxes of a plurality of angles of the light beam emitted from the light source corresponding to the display device, to generate a plurality of luminous flux detection results; and
a logic unit, for determining an angle, corresponding to a luminous flux detection result with a maximum luminous flux among the plurality of luminous flux detection results, as the incident angle according to the plurality of luminous flux detection results.

3. The device of claim 1, wherein the light angle detection module is further utilized for determining intensity of the light source, and detecting the incident angle of the light beam emitted from the light source corresponding to the display device when the intensity of the light source is greater than a third predetermined value.

4. The device of claim 1, wherein the light angle detection module is further utilized for determining intensity of the light source which has a maximum intensity among a plurality of light sources.

5. The device of claim 1, wherein the vision angle detection module comprises:
a distance measurement unit, for measuring a first distance between the user and the display device;
an image capturing unit, for capturing a face image of the user corresponding to the display device; and
a calculating unit, for determining the vision angle of the user corresponding to the display device according to the first distance and the face image.

6. The device of claim 5, wherein the calculating unit identifies eyes of the user in the face image, determines a second distance between the eyes in the face image, determines a third distance between a horizontal line of the eyes of the user and a horizontal line of the face image, and determines the visual angle according to the first distance, the second distance and the third distance.

7. The device of claim 1, wherein the processing module is further utilized for outputting a warning signal when the light source affects the user.

8. The device of claim 1, wherein the first predetermined value equals the second predetermined value.

9. A method for detecting light reflection in an electronic device having a display device, comprising:
detecting an incident angle of light beam emitted from a light source corresponding to the display;
detecting a vision angle of a user corresponding to the display device; and
determining the light source affects the user when the incident angle is smaller than a first predetermined value and the vision angle is smaller than a second predetermined value.

10. The method of claim 9, wherein the step of detecting the incident angle of the light source corresponding to the display device comprises:
detecting luminous flux of a plurality of angles of the light beam emitted from the light source corresponding to the display device, to generate a plurality of luminous flux detecting results; and
determining an angle, corresponding to a luminous flux detecting result with a maximum luminous flux among the plurality of luminous flux detecting results, as the incident angle according to the plurality of luminous flux detecting results.

11. The method of claim 9, further comprising determining intensity of the light source, and detecting the incident angle of the light beam emitted from the light source corresponding to the display device when the intensity of the light source is greater than a third predetermined value.

12. The method of claim 9, further comprising determining intensity of the light source which has a maximum intensity among a plurality of light sources.

13. The method of claim 9, wherein the step of detecting the vision angle of the user corresponding to the display device comprises:
measuring a first distance between the user and the display device;
capturing a face image of the user corresponding to the display device; and
determining the vision angle of the user corresponding to the display device according to the first distance and the face image.

14. The method of claim 13, wherein the step of determining the vision angle of the user corresponding to the display device according to the first distance and the face image comprises:
identifying eyes of the user in the face images;
determining a second distance between the eyes in the face image;
determining a third distance between a horizontal line of the eyes of the user and a horizontal line of the face image; and
determining the vision angle according to the first distance, the second distance and the third distance.

15. The method of claim 9, further comprising outputting a warning signal when the light source affects the user.

16. An electronic device, comprising:
an operating circuit;
a display device, controlled by the operating circuit, for display images; and
a device for detecting light reflection, comprising:
a light angle detection module, for detecting an incident angle of a light beam emitted from a light source corresponding to the display device;
a vision angle detection module, for detecting an vision angle of a user corresponding to the display device; and
a processing module, for determining the light source affects the user when the incident angle is smaller than a first predetermined value and the vision angle is smaller than a second predetermined value.

17. The electronic device of claim 16, wherein light angle detection module comprises:
a plurality of luminous flux detectors, for detecting luminous fluxes of a plurality of angles of the light beam emitted from the light source corresponding to the display device, to generate a plurality of luminous flux detection results; and
a logic unit, for determining an angle, corresponding to a luminous flux detection result with a maximum luminous flux among the plurality of luminous flux detection results, as the incident angle according to the plurality of luminous flux detection results.

18. The electronic device of claim 16, wherein the light angle detection module is further utilized for determining intensity of the light source, and detecting the incident angle of the light beam emitted from the light source corresponding to the display device when the intensity of the light source is greater than a third predetermined value.

19. The electronic device of claim 16, wherein the light angle detection module is further utilized for determining intensity of the light source which has a maximum intensity among a plurality of light sources.

20. The electronic device of claim 16, wherein the vision angle detection module comprises:
a distance measurement unit, for measuring a first distance between the user and the display device;
an image capturing unit, for capturing a face image of the user corresponding to the display device; and
a calculating unit, for determining the visual angle of the user corresponding to the display device according to the first distance and the face image.
